(19) United States
(12) Patent Application Publication
(10) Pub. No.: US 2020/0372556 A1
(43) Pub. Date: Nov. 26, 2020

(54) METHOD AND SYSTEM FOR PROVIDING REAL-TIME REQUESTS OF TRANSPORT SERVICES

(71) Applicants: Calvin WATTS, Washington, DC (US); Fizel JABBAR, Washington, DC (US)

(72) Inventors: Calvin WATTS, Washington, DC (US); Fizel JABBAR, Washington, DC (US)

(21) Appl. No.: 16/883,752

(22) Filed: May 26, 2020

Related U.S. Application Data
(60) Provisional application No. 62/852,654, filed on May 24, 2019.

(51) Int. Cl. G06Q 30/06; G06Q 50/30; G06Q 50/28; G06Q 50/26; G06Q 30/00; G06Q 30/02; G06Q 10/00

(52) U.S. Cl. CPC G06Q 30/0605; G06Q 50/30; G06Q 30/0645; G06Q 50/28; G06Q 30/0631; G06Q 30/0185; G06Q 30/0282; G06Q 10/20; G06Q 30/0283; G06Q 50/265

(57) ABSTRACT

An approach is provided for determining one or more service providers based on a plurality of attribute information for performing a service type. The approach involves receiving, an input via a user interface of a device, wherein the input specifies service attribute information, user attribute information, or a combination thereof. The approach further involves processing the input to determine a service type, wherein the service type includes a delivery service, a vehicle rental service, a moving service, a junk removal service, a curbside pickup service, a labor service, or a combination thereof. The approach also involves determining one or more service providers for the service type based on vehicle attribute information, labor attribute information, or a combination thereof. The approach further involves initiating a display, by the user interface, of the one or more service providers for selection by a user.

### BACKGROUND

Consumers, particularly in an urban setting, rely on public transportation or compact vehicles to travel to stores to purchase items. However, if the items are of significant size or unwieldy, a consumer may be deterred from purchasing the item as delay and/or high expense in delivery are traditionally the demotivating factors. Additionally, people move or relocate for several reasons, e.g., a new job, a new house, a better neighborhood, or a shorter commute; however, the logistics involved with moving can be stressful and time-consuming, not to mention cost-prohibitive if only a few items need be transported, particularly within close proximity. Traditionally, even if the consumer wishes to rent a vehicle and transport a particular item, such consumer will need to hire another mover or burden a friend, family member or colleague to assist in the transport of the item (which generally will be of a size and weight to require one or more other helpers).

### SOME EXAMPLE EMBODIMENTS

Therefore, there is a need for an approach for determining one or more service providers based on a plurality of attribute information for performing a service type.

According to one embodiment, a method comprises: receiving, an input via a user interface of a device, wherein the input specifies service attribute information, user attribute information, or a combination thereof. The method also comprises processing the input to determine a service type, wherein the service type includes a delivery service, a vehicle rental service, a moving service, a junk removal service, a curbside pickup service, a labor service, or a combination thereof. The method further comprises determining one or more service providers for the service type based on vehicle attribute information, labor attribute information, or a combination thereof. The method also comprises initiating a display, by the user interface, of the one or more service providers for selection by a user.

According to another embodiment, an apparatus comprises at least one processor, and at least one memory including computer program code for one or more computer programs, the at least one memory and the computer program code configured to, with the at least one processor, cause, at least in part, the apparatus to receive, an input via a user interface of a device, wherein the input specifies service attribute information, user attribute information, or a combination thereof. The apparatus is also caused to process the input to determine a service type, wherein the service type includes a delivery service, a vehicle rental service, a moving service, a junk removal service, a curbside pickup service, a labor service, or a combination thereof. The apparatus is further caused to determine one or more service providers for the service type based on vehicle attribute information, labor attribute information, or a combination thereof. The apparatus is also caused to initiate a display, by the user interface, of the one or more service providers for selection by a user.

According to one embodiment, a method comprises: receiving, a request via a user interface of a device, for a transport service for an item. The method also comprises processing item attribute information for the item, user attribute information for a user requesting the transport service, or a combination thereof, wherein the item attribute information includes an item type, a size of the item, a weight of the item, a quantity of the item, or a combination thereof. The method further comprises processing vehicle attribute information, labor attribute information, or a combination thereof associated with a user providing the transport service, wherein the vehicle attribute information includes a size of a vehicle, a vehicle capacity, or a combination thereof. The method also comprises determining a vehicle, a labor, or a combination thereof based on the processing. The method further comprises initiating a notification in the user interface of the device associated with the user providing the transport service.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (or derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing a method of any of the claims.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of determining one or more service providers based on a plurality of attribute information for performing a service type, according to one example embodiment;

FIG. 2 is a diagram of the components of a service request platform, according to one embodiment;

FIG. 3A is a flowchart of a process for determining one or more service providers based on a plurality of attribute information for performing a service type, according to one example embodiment;

FIG. 3B is a flowchart of a process for determining one or more service providers based on safety information, background check information, or a combination thereof;

FIG. 3C is a flowchart of a process for determining one or more service providers based on usage history, a usage pattern, planned use of a vehicle, or a combination thereof;

FIG. 3D is a flowchart of a process for ranking one or more service provides based on a plurality of attribute information;

FIG. 3E is a flowchart of a process for selecting and notifying one or more vehicles and/or one or more labors for performing a service type, according to one example embodiment;

FIG. 3F is a flowchart of a process for comparing the specification of an item with the specification of the vehicle to determine safety levels, according to one example embodiment;

FIG. 3G is a flowchart of a process for selecting a vehicle based on a pre-determined safety threshold, according to one example embodiment;

FIG. 3H is a flowchart of a process for selecting labor based on a pre-determined safety threshold, according to one example embodiment;

FIGS. 4 A-B are user interface diagrams that represent a scenario wherein a user is requesting a moving-related service, according to one example embodiment;

FIGS. 5 A-B are user interface diagrams for selecting a vehicle for moving-related services, according to one example embodiment;

FIGS. 5 C-D are user interface diagrams representing real-time positions of one or vehicles for performing a service type, according to one example embodiment;

FIGS. 6 A-C are user interface diagrams for selecting helpers for moving-related services, according to one example embodiment;

FIGS. 6 D-E are user interface diagrams representing real-time positions of one or helpers for performing a service type, according to one example embodiment;

FIGS. 7 A-G are user interface diagrams for selecting vehicle types and the type of helpers for moving-related services, according to one example embodiment;

FIG. 8 is a diagram of hardware that can be used to implement an embodiment;

FIG. 9 is a diagram of a chip set that can be used to implement an embodiment; and

FIG. 10 is a diagram of a mobile terminal (e.g., handset) that can be used to implement an embodiment.

### DESCRIPTION OF SOME EMBODIMENTS

Examples of a method, apparatus, and computer program for dynamically requesting a vehicle and/or a helper to assist with the transport of items, wherein the request may be based on location information, temporal information, and pricing information are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

FIG. 1 is a diagram of a system capable of dynamically requesting one or more service providers based on a plurality of attribute information for performing a service type. Numerous consumers rely on public transportation, e.g., buses, taxis, compact vehicles, etc., to travel to stores to purchase items. However, if the items are large and heavy, they are discouraged from purchasing the items because of the difficulties in finding helpers and/or vehicles in real-time to move the items. In addition, high delivery expenses deter consumers from purchasing items. Moving can be a complicated and time-consuming process, e.g., consumers lack an easy way to move their bulky goods or items to and from their home or office. The moving or transport process involves several types of services, e.g., packers, haulers, rental vehicles, drivers, temporary storage services, and so on, and the consumers have to visit multiple websites and/or call multiple service providers to get a quote and availability of these services. In other words, having to visit multiple websites and/or call multiple service providers to get prices quotes and availability information may quickly lead to user frustration, thereby discouraging them from using moving-related services. Furthermore, moving companies do not normally move a single item, or moving a few items via moving companies is expensive. In addition, moving companies usually state a long or otherwise inconvenient window for their arrival, and often are scheduled numerous days after the customers' purchase of the item (e.g., furniture, appliance, etc.). Thus, the stress, paucity of time and various other factors related to the impending move cause consumers to often choose a bad service provider resulting in loss or damage of property, and unplanned expenses.

To address this problem, a system 100 of FIG. 1 introduces the capability to process users' requests for a service on a real-time basis. In one example embodiment, the user request comprises a request for moving bulky items from point A to point B, request for a rental vehicle, request for disposing of bulky items, and/or request for an extra set of hands from background checked drivers and helpers who drive pick-up trucks, cargo vans, large SUV's, or box trucks. In another example embodiment, the service comprises small apartment moves, retail store delivery, junk removal, labor only, curbside pickup, or donation drop-off and pickup. Thereafter, system 100 may dynamically request a vehicle and/or a helper to assist with the transport of items, wherein the request may be based on plurality of attribute information, e.g., service attribute information, user attribute information, vehicle attribute information, labor attribute information, etc. System 100 links a user with a vehicle of his/her choice within a short period of time, e.g., 15 minutes to 1 hour, and provides an easy, fast, affordable, and safe alternative for moving users' items on demand.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.). In one embodiment, the UE 101 may be associated with the vehicle 111a or be a component part of the vehicle 111a.

By way of example, the applications 103 may be any type of application that is executable at the UE 101, such as content provisioning services, camera/imaging application, media player applications, social networking applications, calendar applications, and the like. In one embodiment, one of the applications 103 at the UE 101 may act as a client for the service request platform 109 and perform one or more functions associated with the functions of the service request platform 109 by interacting with the service request platform 109 over the communication network 107.

By way of example, the sensors 105 may be any type of sensor. In certain embodiments, the sensors 105 may include, for example, a global positioning sensor for gathering location data, a network detection sensor for detecting wireless signals or receivers for different short-range communications (e.g., Bluetooth, Wi-Fi, Li-Fi, near field communication (NFC) etc.), temporal information sensors, a camera/imaging sensor for gathering image data, an audio recorder for gathering audio data, and the like. In one example embodiment, the UE 101 may include GPS receivers to obtain geographic coordinates from satellites 119 for determining real-time location of the requested service providers. Further, the location can be determined by a triangulation system such as A-GPS, Cell of Origin, or other location extrapolation technologies.

The communication network 107 of system 100 includes one or more networks such as a data network, a wireless network, a telephony network, or any combination thereof. It is contemplated that the data network may be any local area network (LAN), metropolitan area network (MAN), wide area network (WAN), a public data network (e.g., the Internet), short-range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (Wi-Fi), wireless LAN (WLAN), Bluetooth®, Internet Protocol (IP) data casting, satellite, mobile ad-hoc network (MANET), and the like, or any combination thereof.

In one embodiment, service request platform 109 may be a platform with multiple interconnected components. The service request platform 109 may include multiple servers, intelligent networking devices, computing devices, components, and corresponding software for determining one or more service providers based on a plurality of attribute information for performing a service type. In addition, it is noted that the service request platform 109 may be a separate entity of the system 100, a part of the one or more services 115a-115n (collectively referred to as services 115), or included within the UE 101 (e.g., as part of the applications 103). In one embodiment, the service request platform 109 may receive a request from user 111b, e.g., service requesting users, for at least one service, e.g., a moving-related service. Then, the service request platform 109 may determine service attribute information and/or user attribute information associated with the request to further determine a service type. Thereafter, the service request platform 109 may determine service providers for the determined service type based on vehicle attribute information and/or labor attribute information. Next, the service request platform 109 may initiate a user interface display of the service providers in UE 101 for selection by user 111b. In one example embodiment, user A plans to move a large item, e.g., a dining table, to another location. User A sends a request via her UE 101 for a service, whereupon service request platform 109 processes the request to determine the size and weight of the item, the quantity of the item, the pick-up and drop-off locations, the budget information, and the timing information. Thereafter, service request platform 109 determines a service type, e.g., delivery service, a vehicle rental service, a moving service, a junk removal service, a curbside pickup service, a labor service, etc. Subsequently, service request platform 109 may determine service providers, e.g., delivery vehicles, rental vehicles, drivers, packers, haulers, etc., for the determined service type based on vehicle attribute information and/or labor attribute information. Next, the service request platform 109 initiates a user interface display of a list of service providers in UE 101 for selection by the user.

By way of example, vehicle 111a is any vehicle, e.g., a personal vehicle of users, a rented vehicle, a commercial vehicle, pick-up trucks, cargo vans, large SUV's, box trucks, smart vehicles, or self-driving vehicles. In one embodiment, vehicle 111a is equipped with a variety of sensors 105 including but not limited to location sensors, e.g., configured to process signals from positioning satellites 119, e.g., a Global Positioning System (GPS) satellite, and other sensors, e.g., camera sensor, LiDAR sensor, RADAR sensor, etc., to assist in correctly localizing vehicle 111a on maps.

In system 100, users 111b are registered service providers, registered or visiting users, or a combination thereof for a moving-related service. In one embodiment, registered service providers comprise of helpers, packers, haulers, drivers, cleaners, etc. In another embodiment, registered or visiting users are users requesting moving-related services.

By way of example, the service platform 113 may include notification services, social networking services, content (e.g., audio, video, images, etc.) provisioning services, application services, storage services, contextual information determination services, location-based services, information (e.g., weather, news, etc.) based services, etc. In one embodiment, the services platform 113 may interact with the UE 101, the service request platform 109 and the content provider 117 to supplement or aid in the processing of the content information. In one embodiment, the services platform 113 may include any type of real-time moving services, e.g., store purchases, small apartment moves, retail store delivery, junk removal, labor only, curbside pickup, donation drop-off and pickup, disposal of bulky items, providing background checked drivers and helpers, etc.

By way of example, the services 115 may be an online service that reflects the interests and/or activities of users. The services 115 allow users 111b to share location information, activities information, contextual information, historical user information, and interests within their individual networks, and provides for data portability. The services 115 may additionally assist in providing the service request platform 109 with activity information for at least one user in at least one location, user profile information, and a variety of additional information.

The content providers 117a-117n (collectively referred to as content provider 117) may provide content to the UE 101, the service request platform 109, and the services 115 of the service request platform 109. The content provided may be any type of content, such as image content (e.g., pictures), textual content, audio content, video content, etc. In one embodiment, the content provider 117 may provide content that may supplement the content of the applications 103, the sensors 105, or a combination thereof. In one embodiment, the content provider 117 may also store content associated with the UE 101, the service request platform 109, and the services 115 of the services platform 113, e.g., usage history of users, usage patterns of users, safety information of the vehicles, background check information of the service providers, etc. In another embodiment, the content provider 117 may manage access to a central repository of data and offer a consistent, standard interface to data, such as attributes, probe data, and traffic sign information for one or more locations.

By way of example, the UE 101, the service request platform 109, and the content provider 117 communicate with each other and other components of the communication network 107 using well known, new or still developing protocols. In this context, a protocol includes a set of rules defining how the network nodes within the communication network 107 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

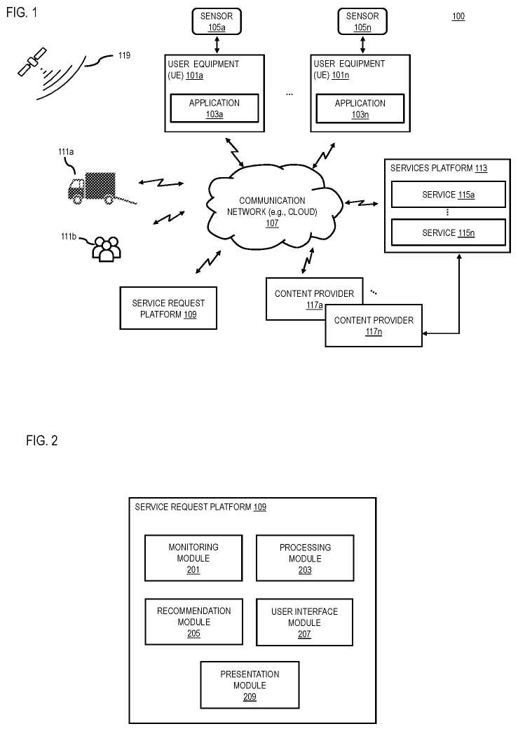

FIG. 2 is a diagram of the components of a service request platform 109, according to one embodiment. By way of example, the service request platform 109 includes one or more components for determining one or more service providers based on a plurality of attribute information for performing a service type. It is contemplated that the functions of these components may be combined in one or more components or performed by other components of equivalent functionality. In this embodiment, the service request platform 109 includes monitoring module 201, processing module 203, recommendation module 205, user interface module 207, and presentation module 209, or any combination thereof.

In one embodiment, monitoring module 201 may monitor in real-time location information and/or temporal information, e.g., operating schedules, of vehicles 111a and users 111b. In another embodiment, monitoring module 201 may monitor in real-time nearby environment, the traffic conditions, the weather conditions, or a combination thereof around the pick-up location and/or the drop-off location. Thereafter, the monitoring module 201 may coordinate with processing module 203 to process the monitored data for transmittal to recommendation module 205 for an optimal recommendation of one or more service providers for at least one service.

In one embodiment, processing module 203 may process location information, temporal information, nearby environment, the traffic conditions, and the weather conditions received from recommendation module 205. In another embodiment, the processing module 203 may process historical information, preference information, budget information, or a combination thereof associated with users 111b, e.g., users requesting a service. In a further embodiment, processing module 203 may process proximity information, safety information, background check information, availability information, or a combination thereof associated with the one or more service providers, e.g., vehicles 111a and users 111b. Thereafter, processing module 203 may coordinate with the recommendation module 205 for an optimal recommendation of one or more service providers to perform at least one service.

In one embodiment, recommendation module 205 may recommend the plurality of service providers for performing a service type, e.g., generating a list of vehicles and/or helpers for performing moving-related services, in a user interface of UE 101. In another embodiment, recommendation module 205 may present a ranking of the service providers in a user interface of UE 101 for selection by the user. The ranking of the service providers is based on service attribute information and/or user attribute information. In one example embodiment, recommendation module 205 may rank one or more vehicles based on total rental cost of the vehicles, proximity to the pick-up location, safety information, etc. In another example embodiment, recommendation module 205 may rank one or more helpers, e.g., drivers, packers, labors, or haulers, based on total labor cost, proximity to the pick-up location, background check information, etc.

In one embodiment, user interface module 207 may generate user interface elements, e.g., presentation of a plurality of data types, in response to the detection of input from for users 111b via their respective UE 101. In one example embodiment, user interface module 207 may generate user interface elements representing the plurality of vehicles upon detecting that a user has requested for vehicles from a moving service application via his/her UE 101. In one embodiment, the user interface module 207 employs various application programming interfaces (APIs) or other function calls corresponding to the application 103 of UE 101; thus enabling the display of graphics primitives such as menus, data entry fields, etc., for generating the user interface elements. Still further, the user interface module 207 may be configured to operate in connection with augmented reality (AR) processing techniques, wherein various different applications, graphic elements, and features may interact.

In one embodiment, presentation module 209 obtains a set of summary statistics and/or updates from the other modules. Thereafter, the presentation module 209 may present a user interface in a UE 101 and/or at least one website in a UE 101 that allows a service requesting user 111b to select a service provider to perform a service type, e.g., moving-related service. In another embodiment, presentation module 209 may generate a presentation of at least one notification in the UE 101 of helpers, e.g., drivers, packers, haulers, cleaners, etc., requesting them to travel to a particular location to perform moving-related services. In a further embodiment, the presentation module 209 may cause a presentation of at least one notification in a vehicle, e.g., smart vehicle, self-driving vehicles, requesting them to travel to a particular location to perform moving-related services.

The above presented modules and components of service request platform 109 can be implemented in hardware, firmware, software, or a combination thereof. Though depicted as a separate entity in FIG. 1, it is contemplated that the service request platform 109 may be implemented for direct operation by respective UE 101. As such, the service request platform 109 may generate direct signal inputs by way of the operating system of the UE 101 for interacting with the applications 103. In another embodiment, one or more of the modules 201-209 may be implemented for operation by respective UEs, as a service request platform 109. Still further, the service request platform 109 may be integrated for direct operation with the services 115, such as in the form of a widget or applet, in accordance with an information and/or subscriber sharing arrangement. The various executions presented herein contemplate any and all arrangements and models.

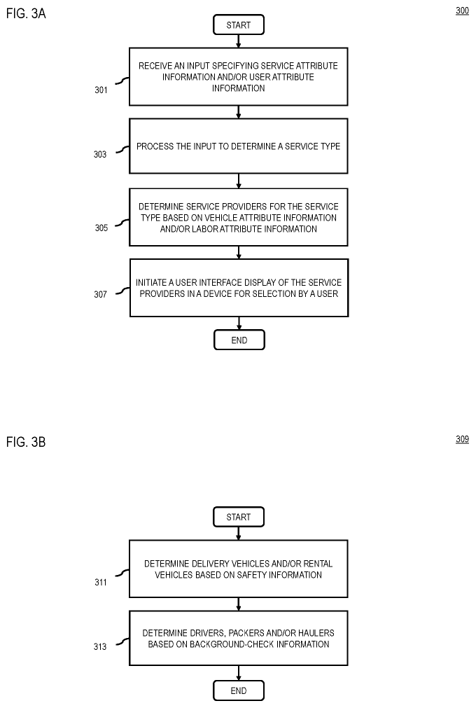

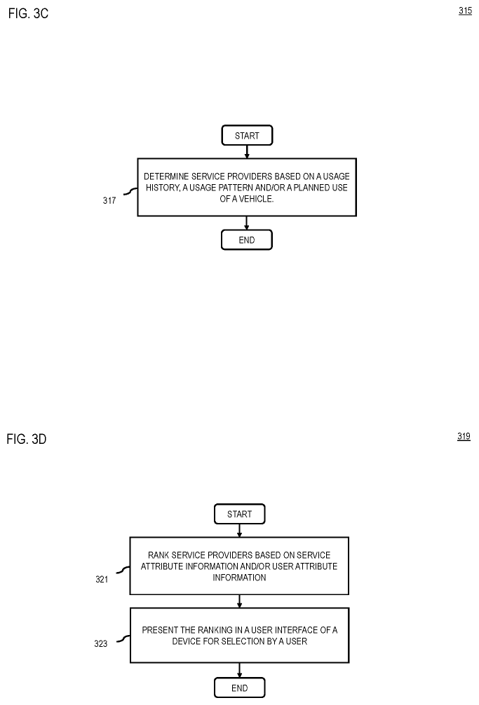

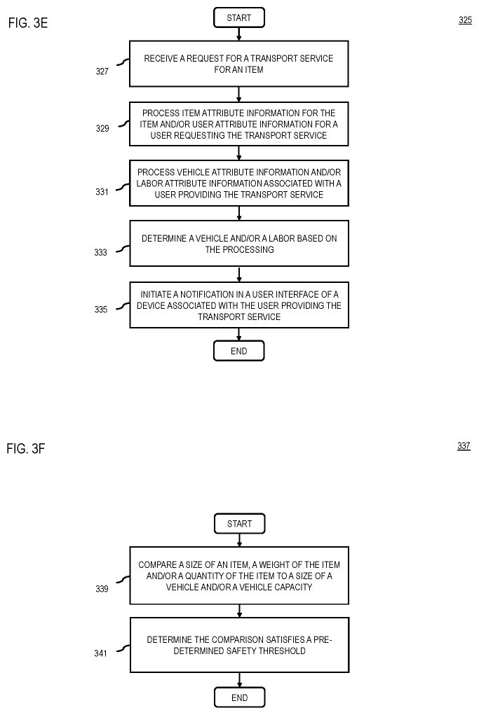

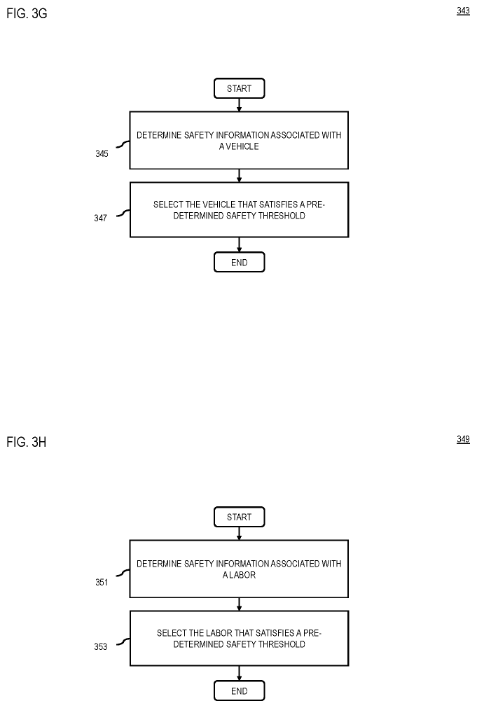

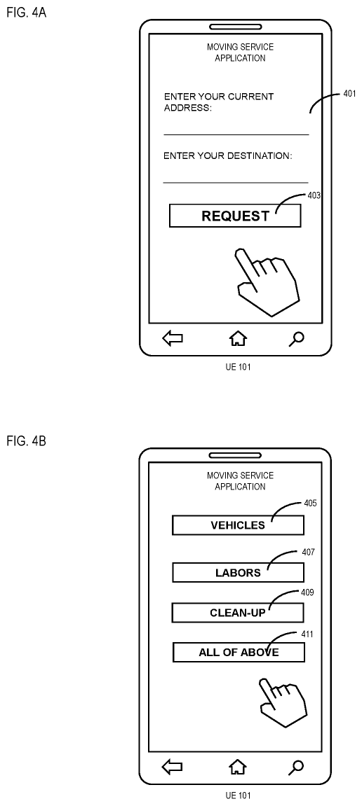

FIG. 3A is a flowchart of a process for determining one or more service providers based on a plurality of attribute information for performing a service type, according to one example embodiment. In one embodiment, the service request platform 109 performs the process 300 and is implemented in, for instance, a chip set including a processor and a memory as shown in FIG. 9.

In step 301, service request platform 109 may receive, input via a user interface element of a device, wherein the input specifies service attribute information, user attribute information, or a combination thereof. In one embodiment, the service attribute information includes an item for a delivery, a size of the item, weight of the item, a quantity of the item, a pick-up location for the item, and/or a drop-off location for the item. In one embodiment, the user attribute information includes budget information, preference information, and/or temporal information for the service type.

In step 303, service request platform 109 may process the input to determine a service type. In one embodiment, the service type includes a delivery service, a vehicle rental service, a moving service, a junk removal service, a curbside pickup service, and/or a labor service. In one example embodiment, service request platform 109 may determine the service type to be a cleaning service based on the nature of the items, e.g., office furniture. In one example embodiment, service request platform 109 may select a group of cleaners from a plurality of helpers for cleaning a rental property, e.g., declutter place of business. In another example embodiment, service request platform 109 may determine the service type to be a moving service based on the size of the items, weight of the items, quantity of the items. In a further example embodiment, service request platform 109 may determine the service type to be a vehicle rental service upon determining current user location, e.g., a user is at a furniture store, and current user activity, e.g., user purchased a 40-inch television.

In step 305, service request platform 109 may determine service providers for a determined service type based on vehicle attribute information and/or labor attribute information. In one embodiment, the vehicle attribute information includes a size of a vehicle, proximity of the vehicle to the pick-up location or the drop-off location for the item, operation hours of the vehicle, and/or a total rental cost of the vehicle. In one example embodiment, service request platform 109 may recommend selecting a mini-truck from a plurality of vehicles for transporting mid-sized items. In one embodiment, the labor attribute information includes proximity of laborers to the pick-up location or the drop-off location for the item, operation hours of the labor, and/or a total labor cost. In one embodiment, one or more service providers include delivery vehicles, rental vehicles, drivers, packers, haulers, and/or cleaners registered with a service, e.g., moving-related service.

In step 307, service request platform 109 initiates a user interface display of the one or more service providers in a device, i.e., UE 101, for selection by a user. In one example embodiment, service request platform 109 may generate a list of service providers and presents the list in the user interface of the UE 101 for the users to select. In another example embodiment, service request platform 109 may rank the service providers and presents the ranking in the user interface of the UE 101 for the users to select. In another embodiment, user interface display includes a temporary parking location or an area for a vehicle to park or stop and/or for a labor to stand for a designated period of time to perform the service type.

FIG. 3B is a flowchart of a process for determining one or more service providers based on safety information and/or background check information. In one embodiment, the service request platform 109 performs the process 309 and is implemented in, for instance, a chip set including a processor and a memory as shown in FIG. 9.

In step 311, service request platform 109 may determine the one or more delivery vehicles and/or one or more rental vehicles based on safety information. In one embodiment, the safety information includes historical accident information for vehicles 111a. In another embodiment, safety information includes past repairs and maintenance records for vehicles 111a. In a further embodiment, safety information includes the year of manufacture and the mileage of vehicles 111a. In one example embodiment, service request platform 109 may select vehicles 111a with no prior accident, minimum repair and maintenance, recent year of manufacture, and lesser mileage.

In step 313, service request platform 109 may determine drivers, packers, and/or haulers based on background check information. In one embodiment, the background check information includes prior accidents record, prior criminal records, and/or prior traffic citation records for users 111b, i.e., service providing users. In one example embodiment, service request platform 109 may select users 111b with no prior accident record, prior criminal record, and/or prior traffic citation record.

FIG. 3C is a flowchart of a process for determining one or more service providers based on usage history, a usage pattern, a planned use of a vehicle, or a combination thereof. In one embodiment, the service request platform 109 performs the process 315 and is implemented in, for instance, a chip set including a processor and a memory as shown in FIG. 9.

In step 317, service request platform 109 may determine service providers based on usage history, usage pattern, planned use of a vehicle, or a combination thereof associated with the user. In one example embodiment, service request platform 109 may process past usage and patterns of users 111b, i.e., service requesting users, to determine preference information. Thereafter, service request platform 109 may recommend service providers in consonance with the preference information of users 111b, i.e., service requesting users.

FIG. 3D is a flowchart of a process for ranking one or more service provides based on a plurality of attribute information. In one embodiment, the service request platform 109 performs the process 319 and is implemented in, for instance, a chip set including a processor and a memory as shown in FIG. 9.

In step 321, service request platform 109 may rank service providers based on the service attribute information and/or user attribute information. In one example embodiment, service request platform 109 may rank one or more vehicles based on total rental cost of the vehicles, proximity to the pick-up location, safety information, etc. In another example embodiment, service request platform 109 may rank one or more helpers, e.g., drivers, packers, labors, cleaners, or haulers, based on total labor cost, proximity to the pick-up location, background check information, etc.

In step 323, service request platform 109 may present the ranking in a user interface of the device for user selection. Upon user selection, service request platform 109 may alert the service providers, e.g., drivers, packers, labors, cleaners, or haulers, in their respective UE 101 to travel to a specific location for performing a service type.

FIG. 3E is a flowchart of a process for selecting and notifying one or more vehicles and/or one or more labors for performing a service type, according to one example embodiment. In one embodiment, service request platform 109 performs the process 325 and is implemented in, for instance, a chip set including a processor and a memory as shown in FIG. 9.

In step 327, service request platform 109 may receive, a request via a user interface of a device, for a transport service for an item. In one example embodiment, user 111b, i.e., a service requesting user, may use the transport service requesting application in his/her UE 101 to request a transport service.

In step 329, service request platform 109 may process item attribute information for the item, user attribute information for a user requesting the transport service, or a combination thereof. In one embodiment, the item attribute information includes an item type, size of the item, the weight of the item, quantity of the item, or a combination thereof. In one embodiment, the user attribute information includes budget information, preference information, temporal information, or a combination thereof.

In step 331, service request platform 109 may process vehicle attribute information, labor attribute information, or a combination thereof associated with a user providing the transport service. In one embodiment, the vehicle attribute information includes a size of a vehicle, a vehicle capacity, or a combination thereof. In one embodiment, the labor attribute information includes operation hours of the labor, a total labor cost, the proximity of the labor to the pick-up location or the drop-off location for the item, or a combination thereof.

In step 333, service request platform 109 may determine a vehicle, a labor, or a combination thereof based on the processing. In one example embodiment, service request platform 109 may select a vehicle that is most suitable for transporting the items, e.g., a service request platform 109 may recommend/select a minitruck for transporting a dining table. The suitability of the vehicle for transporting the item is based on the effortlessness in fitting the item in the vehicle without any damages.

In step 335, service request platform 109 may initiate a notification in the user interface of the device associated with the user providing the transport service. In one embodiment, the user providing the transport service includes one or more drivers, one or more packers, one or more haulers, or a combination thereof registered with the transport service. In one example embodiment, service request platform 109 may generate a presentation of at least one notification in the UE 101 of the user providing the transport service, e.g., drivers, packers, haulers, cleaners, etc., requesting them to travel to a particular location to perform moving-related services.

FIG. 3F is a flowchart of a process for comparing the specification of an item with the specification of the vehicle to determine safety levels, according to one example embodiment. In one embodiment, service request platform 109 performs the process 337 and is implemented in, for instance, a chip set including a processor and a memory as shown in FIG. 9.

In step 339, service request platform 109 may compare the size of the item, the weight of the item, the quantity of the item, or a combination thereof to the size of the vehicle, the vehicle capacity, or a combination thereof.

In step 341, service request platform 109 may determine the comparison satisfies a pre-determined safety threshold. In one example embodiment, service request platform 109 may compare the dimension of an item, e.g., length, breadth, width, and height, with the dimension of a vehicle, length, breadth, and height. The service request platform 109 may determine that the item safely and smoothly fits in the vehicle with ample space around the item, thereby satisfying a pre-determined safety threshold. In another example embodiment, service request platform 109 may compare the weight of the item to the capacity of the vehicle. The service request platform 109 may determine that the weight of the item exceeds or is close to the vehicular capacity, thereby failing the pre-determined safety threshold.

FIG. 3G is a flowchart of a process for selecting a vehicle based on a pre-determined safety threshold, according to one example embodiment. In one embodiment, service request platform 109 performs the process 343 and is implemented in, for instance, a chip set including a processor and a memory as shown in FIG. 9.

In step 345, service request platform 109 may determining safety information associated with the vehicle. In one embodiment, the safety information includes prior accident records, prior repair and maintenance records, year of manufacture, mileage information, or a combination thereof.

In step 347, service request platform 109 may select the vehicle that satisfies the pre-determined safety threshold. In one embodiment, the pre-determined safety threshold requires the vehicles providing transport services to have no prior records of accidents, minimum repair and maintenance, recent years of manufacture, and lesser mileage. In one example embodiment, service request platform 109 may remove from the list vehicles with prior accident records and/or major repair and maintenance records. In another example embodiment, service request platform 109 may remove from the list vehicles manufactured over a specified time threshold, e.g., over 10 years, and/or vehicle that exceeds the mileage limit, e.g., over 89,000 miles.

FIG. 3H is a flowchart of a process for selecting labor based on a pre-determined safety threshold, according to one example embodiment. In one embodiment, service request platform 109 performs the process 349 and is implemented in, for instance, a chip set including a processor and a memory as shown in FIG. 9.

In step 351, service request platform 109 may determine safety information associated with the labor for performing transport-related services. In one embodiment, the safety information includes prior accident record, prior criminal record, prior traffic citation record, or a combination thereof for the labors.

In step 353, service request platform 109 may select the labor that satisfies a pre-determined safety threshold. In one embodiment, the pre-determined safety threshold requires the labors providing transport services to have no prior accident record and/or no prior criminal record. The service request platform 109 may remove from the list labors with prior accident record and/or prior criminal record. In another embodiment, the pre-determined safety threshold requires the labors providing transport services to have no major traffic citation records, e.g., drunk driving, reckless driving, running a traffic light, etc., and minimum minor traffic citation records, e.g., parking violations, seat belt violation, etc.

FIGS. 4 A-B are user interface diagrams that represent a scenario wherein a user is requesting a moving-related service, according to one example embodiment. Adverting to FIG. 4A, one or more users, e.g., registered users or visiting users, may request a service using their mobile devices, e.g., UE 101. In one example embodiment, users may be presented with a notification screen 401 requesting for location information, e.g., current location, pick-up location, and/or drop-off location. The users may enter their location information and then click the graphical user interface (GUI) 403 to proceed to the next step of requesting a moving-related service. Thereafter, in FIG. 4B, users are presented with a plurality of service types, e.g., vehicles 405, labors 407, clean-up 409, and all of above 411. In one example embodiment, users may choose vehicles 405 if they only require a vehicle, e.g., a rental mini truck, to transport the items. In another example embodiment, users may choose labors 407 if they only require labors to move items, e.g., furniture, any objects, etc., into the vehicle from their current location and/or out of their vehicles in the drop-off location. In a further example embodiment, users may choose clean-up 409 if they only require cleaning services, e.g., cleaning the rental properties. In another example embodiment, the user may choose all of above 411 if they require a vehicle with a moving and cleaning crew.

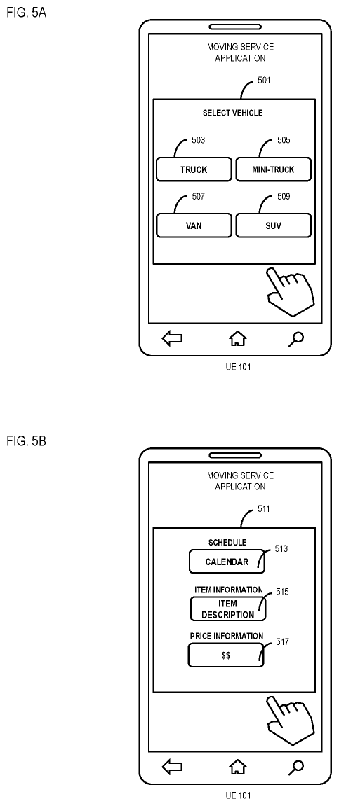

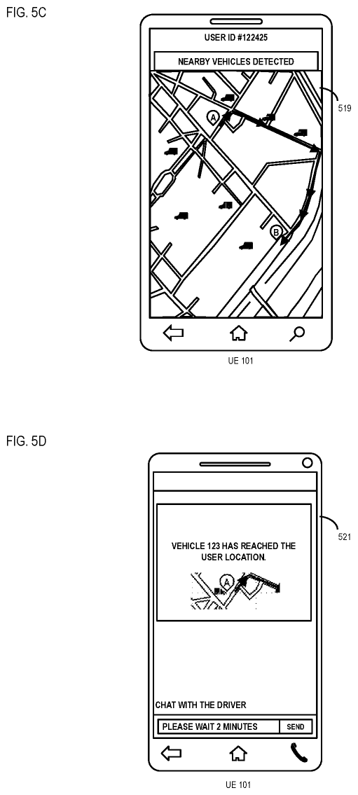

FIGS. 5 A-B are user interface diagrams for selecting a vehicle for moving-related services, according to one example embodiment. This scenario is particularly suitable for users carrying the items themselves and does not need haulers. Referring to FIG. 5A, users are presented with display 501 pursuant to selecting vehicles 405 in FIG. 4B. Thereafter, users may select a vehicle of their preference, e.g., truck 503, mini-truck 505, van 507, or SUV 509. Subsequently, in FIG. 5B, users are presented with display 511 wherein users are requested to enter additional information. In one example embodiment, users may click GUI 513 to provide temporal information, e.g., date and time of service. In another example embodiment, users may click GUI 515 to provide a description for items being transported, e.g., weight information, size information, item types, special handling, etc. In a further example embodiment, the users may click GUI 517 to provide pricing information, e.g., maximum price.

FIGS. 5 C-D are user interface diagrams representing real-time positions of one or vehicles for performing a service type, according to one example embodiment. Adverting to FIG. 5C, service request platform 109 may present display 519 in UE 101 that represents the positions and availability of the plurality of vehicles, e.g., a rented vehicle, a commercial vehicle, pick-up trucks, cargo vans, large SUV's, box trucks, smart vehicles, or self-driving vehicles, etc., for a moving-related service. In one embodiment, the service request platform 109 may process service attribute information and/or user attribute information associated with the users requesting the service. Thereafter, the service request platform 109 may process vehicle attribute information associated with the plurality of vehicles. Subsequently, service request platform 109 may recommend one or more vehicles for a user selection. In another embodiment, service request platform 109 may automatically select a vehicle from the plurality of vehicle for providing a service type, e.g., a moving-related service. In one example embodiment, service request platform 109 may select a low-priced vehicle, e.g., total rental cost within a user's budget, that is closest to the user location, e.g., current location or pick-up location, and is most suitable for transporting the items. Subsequently, the user is presented with a total cost estimate for the service. Once, the user accepts the estimated cost for the service, the request for service is processed and the service provider is notified, e.g., the selected low-priced vehicle is alerted of a new service request. The service request platform 109 may implement a cashless system for security, efficiency, and convenience. The cashless system is a scalable system that allows multiple forms of payments, e.g., credit cards, PayPal®, Apple Pay®, Google Wallet®, etc. Furthermore, such offering of a plurality of payment options is attractive to customers.

As represented in FIG. 5D, service request platform 109 may present display 521 in UE 101 that represents a real-time progression of the selected vehicle towards the users' current location. The service request platform 109 may alert the users as soon as the vehicle reaches users' locations. Furthermore, the users may chat with the drivers of the selected vehicle regarding any change in schedule. In one embodiment, service request platform 109 may disperse payment to the drivers and helpers immediately upon completion of the service.

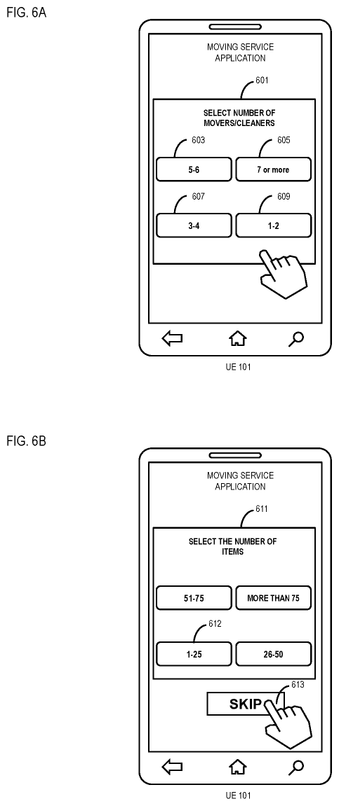

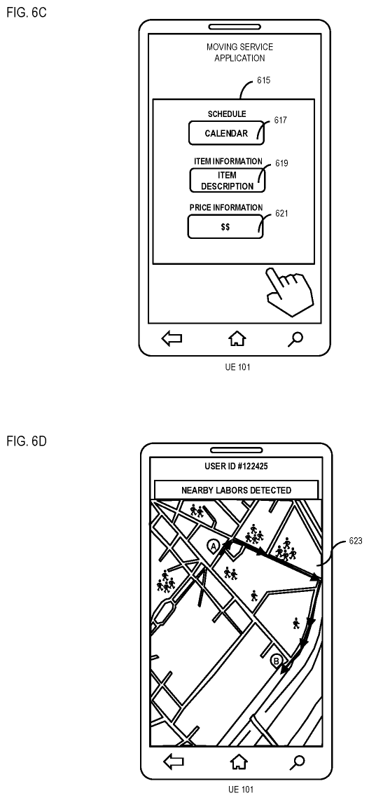

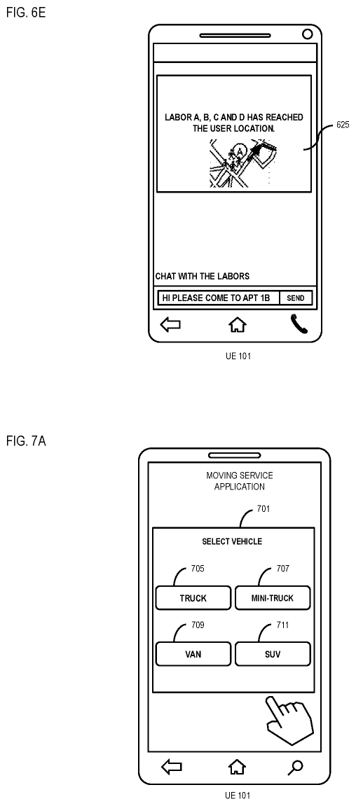

FIGS. 6 A-C are user interface diagrams for selecting helpers for moving-related services, according to one example embodiment. This is especially suitable for users who do not require vehicles but only need labor, e.g., helping hands in moving or lifting bulky items during a move. Referring to FIG. 6A, users are presented with display 601 pursuant to selecting labors 407 and/or clean-up 409 in FIG. 4B. In this embodiment, display 601 comprises GUI 603, 605, 607, and 609 for users to specify the number of labors for the moving-related service. Subsequently, in FIG. 6B, users are presented with display 611 for entering the number of items, e.g., furniture, objects, etc., being moved. In one example embodiment, users may click GUIs 609 and 612 to specify 1-2 labors for moving 1-25 items within the stipulated timeframe of 60 minutes. On the other hand, users may simply click GUI 613 to avoid entering the number of items and proceed to the next step.

Adverting to FIG. 6C, users are presented with display 615 wherein users are requested to enter additional information. In one example embodiment, users may click GUI 617 to provide temporal information, e.g., date and time of service. In another example embodiment, users may click GUI 619 to provide a description for items being transported, e.g., weight information, size information, item types, special handling, etc. In a further example embodiment, the users may click GUI 621 to provide pricing information, e.g., the maximum price for the service, the total value of the items, etc.

FIGS. 6 D-E are user interface diagrams representing the real-time positions of one or helpers for performing a service type, according to one example embodiment. Adverting to FIG. 6D, the service request platform 109 may present display 623 representing the real-time location of a plurality of registered helpers, e.g., drivers, packers, haulers, or cleaners, etc., available for a service type, e.g., a moving-related service. In one embodiment, the service request platform 109 may process location information, preference information, temporal information, item information, and pricing information of the users requesting the service. Thereafter, service request platform 109 may process availability information, proximity information, and cost information of the plurality of helpers, e.g., drivers, packers, haulers, or cleaners, etc. Subsequently, service request platform 109 may recommend a list of helpers for user selection. In another embodiment, service request platform 109 may automatically select a group of helpers for providing moving-related service. In one example embodiment, service request platform 109 may select a low-priced labor group that is closest to the location of a request sending user, e.g., current location or pick-up location, and is most fitting for transporting the items. Subsequently, the user is presented with a cost estimate for the service. Once, the user accepts the estimated cost for the service, the request for service is processed, i.e., the selected helpers are notified in their respective UE 101. The service request platform 109 may implement a cashless system for security, efficiency, and convenience. The cashless system is a scalable system that allows multiple forms of payments, e.g., credit cards, PayPal®, Apple Pay®, Google Wallet®, etc.

Next, as represented in FIG. 6E, service request platform 109 may present display 625 that represents a real-time progression of the selected helpers towards the users' current location. The service request platform 109 may alert the users when the helpers reach the users' current location. Furthermore, the users may chat with the helpers regarding any change in schedule. In one embodiment, the service request platform 109 may disperse payment to the packers, haulers, or cleaners immediately upon completion of the service.

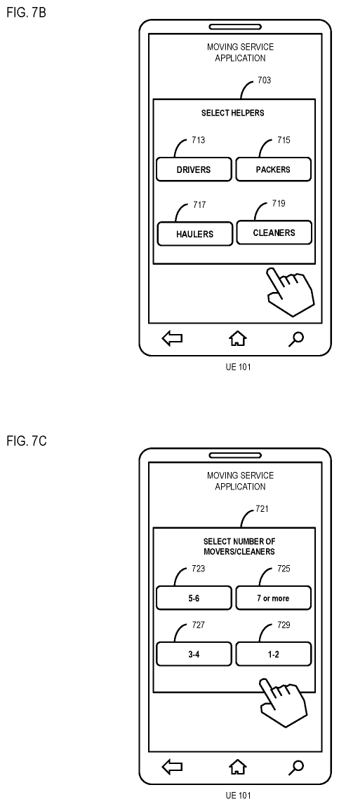

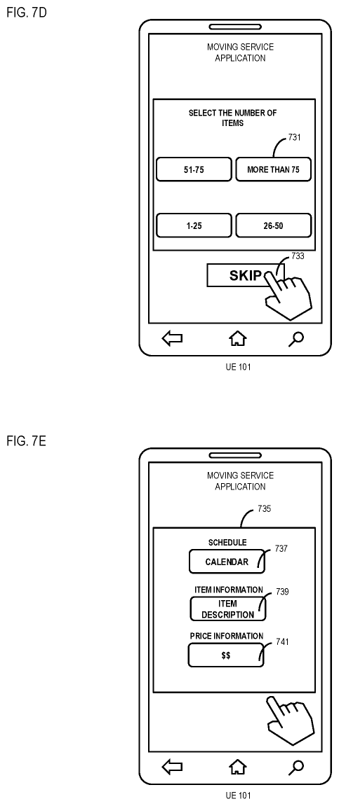

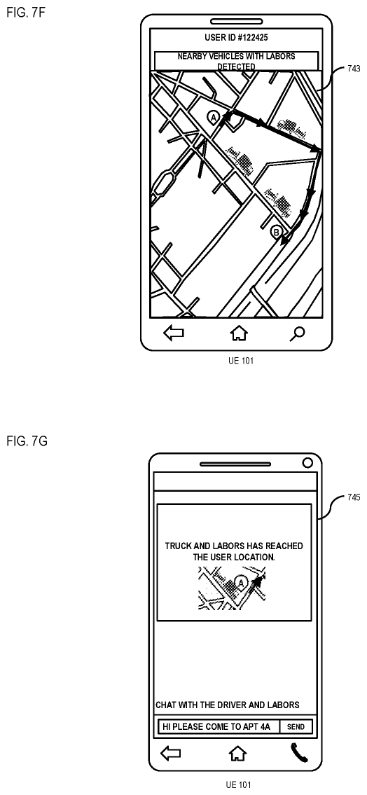

FIGS. 7 A-G are user interface diagrams for selecting vehicle types and the type of helpers for moving-related services, according to one example embodiment. In FIG. 7A, users are presented with display 701 and 703, respectively, pursuant to selecting GUI 411 in FIG. 4B. Referring to FIG. 7A, the users may select a vehicle of their preference, e.g., truck 705, mini-truck 707, van 709, and SUV 711. Subsequently, in FIG. 7B, users may specify the type of labors required for the moving-related services by clicking GUI 713, 715, 717, or 719. Thereafter, in FIG. 7C, users are presented with user interface 721 requesting users to specify the number of labors required for the moving-related services by clicking GUI 723, 725, 727, or 729. Next, in FIG. 7D, users are presented with display 731 to enter the number of items, e.g., furniture, objects, etc., being moved. The users may click GUI 733 to avoid entering the number of items and proceed to the next step.

Adverting to FIG. 7E, users are presented with display 735 wherein users are requested to enter additional information. In one example embodiment, users may click GUI 737 to provide temporal information, e.g., date and time of service. In another example embodiment, users may click GUI 739 to provide a description of items being transported, e.g., weight information, size information, item type, special handling, etc. In a further example embodiment, the users may click GUI 731 to provide pricing information, e.g., maximum price. In one example embodiment, a user may select a GUIs 705, 717, 723, 731, and 737, respectively, to request a truck and 5-6 haulers for moving 100 items within a specified timeframe of 100 minutes.

Thereafter, in FIG. 7F, the service request platform 109 may cause a presentation of display 743 representing the real-time location of a plurality of registered vehicles and helpers available for moving-related service. In one embodiment, service request platform 109 may process location information, preference information, temporal information, item information, and price information of the users requesting the service. Thereafter, service request platform 109 may process availability information, proximity information, and cost information of the plurality of vehicles and helpers. Subsequently, service request platform 109 may recommend one or more vehicles and one or more groups of helpers for providing moving-related service. In another embodiment, service request platform 109 may automatically select a vehicle and a group of helpers for providing moving-related service. In one example embodiment, the service request platform 109 may select a low-priced vehicle and labor group that is closest to the location of a request sending user, e.g., current location or pick-up location, and is most appropriate for transporting the items. Subsequently, the user is presented with a cost estimate for the service. Once, the user accepts the estimated cost for the service, the request for service is processed.

Next, as represented in FIG. 7G, service request platform 109 may present display 745 that represents a real-time progression of the selected vehicle and group of labors towards the users' current location. The service request platform 109 may alert the users when the vehicle and group of labors reach users' current location. Furthermore, the users can chat with the driver of the vehicle and the group of labors regarding any change in schedule. In one embodiment, service request platform 109 may disperse payment to the drivers and helpers immediately upon completion of the service.

The processes described herein for determining one or more service providers based on a plurality of attribute information for performing a service type may be advantageously implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

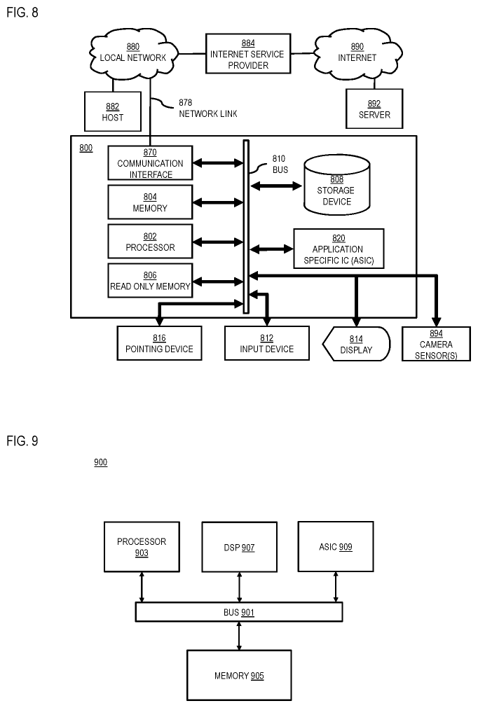

FIG. 8 illustrates a computer system 800 upon which an embodiment of the invention may be implemented. Computer system 800 is programmed (e.g., via computer program code or instructions) to determine one or more service providers based on a plurality of attribute information for performing a service type as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 810 includes one or more parallel conductors of information so that information is transferred quickly among devices coupled to the bus 810. One or more processors 802 for processing information are coupled with the bus 810.

A processor 802 performs a set of operations on information as specified by computer program code related to determine one or more service providers based on a plurality of attribute information for performing a service type. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or other dynamic storage device, stores information including processor instructions for determining one or more service providers based on a plurality of attribute information for performing a service type. Dynamic memory allows information stored therein to be changed by the computer system 800. RANI allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for determining one or more service providers based on a plurality of attribute information for performing a service type, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT) or a liquid crystal display (LCD), or plasma screen or printer for presenting text or images, and a pointing device 816, such as a mouse or a trackball or cursor direction keys, or motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of application specific ICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 107 for providing one or more service providers based on a plurality of attribute information for performing a service type to the UE 101.

The term computer-readable medium is used herein to refer to any medium that participates in providing information to processor 802, including instructions for execution. Such a medium may take many forms, including, but not limited to, non-volatile media, volatile media and transmission media. Non-volatile media include, for example, optical or magnetic disks, such as storage device 808. Volatile media include, for example, dynamic memory 804. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system can be deployed in various configurations within other computer systems, e.g., host 882 and server 892.

FIG. 9 illustrates a chip set 900 upon which an embodiment of the invention may be implemented. Chip set 900 is programmed to determine one or more service providers based on a plurality of attribute information for performing a service type as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set can be implemented in a single chip.

In one embodiment, the chip set 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to determine one or more service providers based on a plurality of attribute information for performing a service type. The memory 905 also stores the data associated with or generated by the execution of the inventive steps.

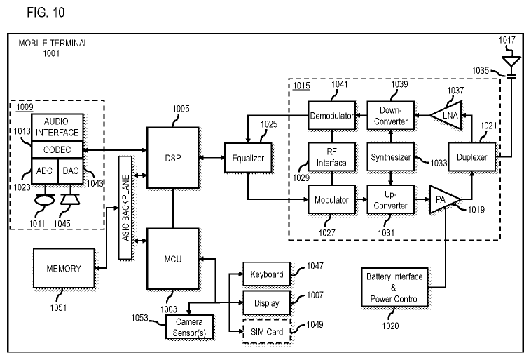

FIG. 10 is a diagram of exemplary components of a mobile terminal (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile station functions that offer automatic contact matching. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile station 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003—which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile station 1001 to determine one or more service providers based on a plurality of attribute information for performing a service type. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the station. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile station 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable computer-readable storage medium known in the art including non-transitory computer-readable storage medium. For example, the memory device 1051 may be, but not limited to, a single memory, CD, DVD, ROM, RAM, EEPROM, optical storage, or any other non-volatile or non-transitory storage medium capable of storing digital data.

An optionally incorporated SIM card 1049 carries, for instance, important information, such as the cellular phone number, the carrier supplying service, subscription details, and security information. The SIM card 1049 serves primarily to identify the mobile station 1001 on a radio network. The card 1049 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
receiving, an input via a user interface of a device, wherein the input specifies service attribute information, user attribute information, or a combination thereof;
processing the input to determine a service type, wherein the service type includes a delivery service, a vehicle rental service, a moving service, a junk removal service, a curbside pickup service, a labor service, or a combination thereof;
determining one or more service providers for the service type based on vehicle attribute information, labor attribute information, or a combination thereof; and
initiating a display, by the user interface, of the one or more service providers for selection by a user.

2. The method of claim 1, wherein the service attribute information includes an item for a delivery, a size of the item, a weight of the item, a quantity of the item, a pick-up location for the item, a drop-off location for the item, or a combination thereof; wherein the user attribute information includes budget information, preference information, temporal information, or a combination thereof for the service type; wherein the vehicle attribute information includes a size of a vehicle, a proximity of the vehicle to the pick-up location or the drop-off location for the item, operation hours of the vehicle, a total rental cost of the vehicle, or a combination thereof; and wherein the labor attribute information includes a proximity of a labor to the pick-up location or the drop-off location for the item, operation hours of the labor, a total labor cost, or a combination thereof.

3. The method of claim 1, wherein the one or more service providers include one or more delivery vehicles, one or more rental vehicles, one or more drivers, one or more packers, one or more haulers, or a combination thereof registered with a service.

4. The method of claim 3, further comprising:
determining the one or more delivery vehicles, the one or more rental vehicles, or a combination thereof based on safety information; and
determining the one or more drivers, the one or more packers, the one or more haulers, or a combination based on background check information.

5. The method of claim 1, further comprising:
determining the one or more service providers based on a usage history, a usage pattern, a planned use of a vehicle, or a combination thereof associated with the user.

6. The method of claim 1, further comprising:
ranking the one or more service providers based on the service attribute information, the user attribute information, or a combination thereof; and
presenting the ranking in a user interface of the device for selection by the user.

7. The method of claim 1, wherein the user interface display includes a temporary parking location or an area for a vehicle to park or stop, for a labor to stand, or a combination thereof for a designated period of time to perform the service type.

8. An apparatus comprising:
at least one processor; and
at least one memory including computer program code for one or more programs, the at least one memory and computer program code configured to, with the at least one processor, cause the apparatus to perform at least the following:
receive, an input via a user interface of a device, wherein the input specifies service attribute information, user attribute information, or a combination thereof;
process the input to determine a service type, wherein the service type includes a delivery service, a vehicle rental service, a moving service, a junk removal service, a curbside pickup service, a labor service, or a combination thereof;
determine one or more service providers for the service type based on vehicle attribute information, labor attribute information, or a combination thereof; and
initiate a display, by the user interface, of the one or more service providers for selection by a user.

9. The apparatus of claim 8, wherein the service attribute information includes an item for a delivery, a size of the item, a weight of the item, a quantity of the item, a pick-up location for the item, a drop-off location for the item, or a combination thereof; wherein the user attribute information includes budget information, preference information, temporal information, or a combination thereof for the service type; wherein the vehicle attribute information includes a size of a vehicle, a proximity of the vehicle to the pick-up location or the drop-off location for the item, operation hours of the vehicle, a total rental cost of the vehicle, or a combination thereof; and wherein the labor attribute information includes a proximity of a labor to the pick-up location or the drop-off location for the item, operation hours of the labor, a total labor cost, or a combination thereof.

10. The apparatus of claim 8, wherein the one or more service providers include one or more delivery vehicles, one or more rental vehicles, one or more drivers, one or more packers, one or more haulers, or a combination thereof registered with a service.

11. The apparatus of claim 10, further comprising:
determine the one or more delivery vehicles, the one or more rental vehicles, or a combination thereof based on safety information; and
determine the one or more drivers, the one or more packers, the one or more haulers, or a combination based on background check information.

12. The apparatus of claim 8, further comprising:
determine the one or more service providers based on a usage history, a usage pattern, a planned use of a vehicle, or a combination thereof associated with the user.

13. The apparatus of claim 8, further comprising:
rank the one or more service providers based on the service attribute information, the user attribute information, or a combination thereof; and
present the ranking in a user interface of the device for selection by the user.

14. The apparatus of claim 8, wherein the user interface display includes a temporary parking location or an area for a vehicle to park or stop, for a labor to stand, or a combination thereof for a designated period of time to perform the service type.

15. A method comprising:
receiving, a request via a user interface of a device, for a transport service for an item;
processing item attribute information for the item, user attribute information for a user requesting the transport service, or a combination thereof, wherein the item attribute information includes an item type, a size of the item, a weight of the item, a quantity of the item, or a combination thereof;
processing vehicle attribute information, labor attribute information, or a combination thereof associated with a user providing the transport service, wherein the vehicle attribute information includes a size of a vehicle, a vehicle capacity, or a combination thereof;
determining a vehicle, a labor, or a combination thereof based on the processing; and
initiating a notification in the user interface of the device associated with the user providing the transport service.

16. The method of claim 15, wherein determining the vehicle further comprises:
comparing the size of the item, the weight of the item, the quantity of the item, or a combination thereof to the size of the vehicle, the vehicle capacity, or a combination thereof; and
determining the comparison satisfies a pre-determined safety threshold.

17. The method of claim 16, further comprising:
determining safety information associated with the vehicle, wherein the safety information includes prior accident records, prior repair and maintenance records, year of manufacture, mileage information, or a combination thereof; and
selecting the vehicle that satisfies the pre-determined safety threshold.

18. The method of claim 15, wherein the user attribute information includes budget information, preference information, temporal information, or a combination thereof; and
wherein the labor attribute information includes operation hours of the labor, a total labor cost, a proximity of the labor to the pick-up location or the drop-off location for the item, or a combination thereof.

19. The method of claim 18, wherein determining the labor further comprises:
determining safety information associated with the labor, wherein the safety information includes prior accident record, prior criminal record, prior traffic citation record, or a combination thereof; and
selecting the labor that satisfies a pre-determined safety threshold.

20. The apparatus of claim 15, wherein the user providing the transport service includes one or more drivers, one or more packers, one or more haulers, or a combination thereof registered with the transport service.
